(19) United States
(12) Patent Application Publication
(10) Pub. No.: US 2003/0113523 A1
(43) Pub. Date: Jun. 19, 2003

(54) Silanated copper foils, method of making, and use thereof

(76) Inventors: Vincent R. Landi, Phoenix, AZ (US); Ki-Soo Kim, Ashford, CT (US); John T. Neill, Woodstock, CT (US)

Correspondence Address: CANTOR COLBURN, LLP, 55 GRIFFIN ROAD SOUTH, BLOOMFIELD, CT, 06002

(21) Appl. No.: 10/224,867

(22) Filed: Aug. 21, 2002

Related U.S. Application Data
(60) Provisional application No. 60/314,193, filed on Aug. 22, 2001.

(51) Int. Cl. B32B 3/00

(52) U.S. Cl. 428/209; 428/447

(57) ABSTRACT

A coated foil comprises a thick silane layer disposed on the copper foil, wherein the silane layer is present in an amount greater than or equal to about 0.1 gram per square meter. The copper foil may further comprise thermal barrier. The silanated copper foil may further comprise an elastomer layer disposed on a side of the thick silane layer opposite the copper foil. When the silanated copper foil is used in the manufacture of circuit materials the circuit materials demonstrate improved bond retention after exposure to acidic processing conditions.

### CROSS-REFERENCE TO RELATED APPLICATIONS

This application claims priority to U.S. Provisional Application No. 60/314,193, filed Aug. 22, 2001, which is incorporated herein by reference in its entirety.

### BACKGROUND OF INVENTION

This invention relates to circuit board materials, and in particular to copper foils used to make circuit board materials.

Printed circuit boards (PCBs) are components of electronic devices made from laminates, which comprise a conductive foil, usually copper, and a polymeric substrate. The copper foils form the conductors in electronic devices and the polymeric substrate forms an insulator between copper foils. The copper foils and insulator are in intimate contact and the adhesion between them contributes to the performance and reliability of electronic devices made with them.

Electrodeposited copper foils used in the manufacture of PCBs go through bonding treatment steps to achieve rough surfaces that increase adhesion to the polymers. The bonding treatment is sometimes followed by deposition of a very thin layer of zinc or zinc alloy, a so-called thermal barrier layer. This barrier treatment has been found to protect the circuit board from a loss of bond strength that may be caused by high temperature lamination of copper to the dielectric substrate. The barrier layer, however, can also be associated with the effect of undercutting or “red-ring” in the processes of fabricating PCBs involving acidic solution. Undercut can be easily recognized when the conductor lines, peeled back from the polymer substrate, exhibit outside margins quite different in color or appearance from the normal copper surface. In some instances a pinkish or reddish coloration appears, known as “red ring”, from the normal surface unaffected by acid or zinc alloy. This acid undercut results in reduction of bond strength (copper peel strength), which is an undesirable phenomenon. Even copper foils without a barrier layer can exhibit loss in bond strength following acidic processing.

Efforts to produce copper foils for circuit board materials that are resistant to acid undercut have been described, for example, in EP 1 089 603 A2, which discloses manufacturing copper foils by co-electrodeposition of copper/arsenic on a bond enhancing layer and then electrodeposition of zinc or zinc alloy on the copper/arsenic layer. This process requires a special electrodeposition step involving a toxic arsenic compound. U.S. Pat. No. 4,642,161 discloses a method comprising forming a copper oxide layer on the surface of copper and reducing the copper oxide to metallic copper with a reducing agent, e.g., dimethylamine borane. The treated copper foils have a good acid resistant bonding interface. This method is suitable for copper foils that do not have zinc thermal barrier layer, but requires oxidation and reduction of the copper surface.

U.S. Pat. Nos. 4,923,734 and 5,622,782 describe treatment of copper foil surfaces with silane solutions as an adhesion promoter in the manufacture of PCB materials. WO 99/20705 describes the application of organofunctional silane/non-organofunctional silane to metal surfaces to enhance adhesion of rubber. However, these patents do not address the highly acidic environments encountered in processes for preparing high performance circuit boards such as ENIG (Electroless Nickel-Immersion Gold) plating processes. U.S. Pat. Nos. 5,750,197 and 6,261,638 B1 disclose a method of preventing corrosion of metals in an atmospheric environment, comprising treatment of a metal surface first with solution of multifunctional silane and then with organofunctional silane. These patents do not describe protection of copper foils from acidic solution. The silane layers deposited on copper foils for either promoting adhesion or preventing corrosion s are disclosed as being very thin, i.e., between about 100 and 1000 Angstroms. Accordingly, there remains a need in the art for methods for economically and efficiently producing a copper foil which, when part of circuit board material, is resistant to acid undercut.

### SUMMARY OF INVENTION

The above-discussed and other drawbacks and deficiencies of the prior art are overcome or alleviated by use of a coated copper foil, wherein the copper foil is coated with a thick silane layer present in an amount greater than or equal to about 0.1 grams per square meter (g/m²). The copper foil may further comprise a zinc thermal barrier. The coated copper foil may further comprise an adhesion promoting elastomer layer disposed on top of the thick silane layer.

In another aspect, a circuit material comprises a silane layer disposed between a copper foil and a circuit substrate (dielectric), wherein the silane layer is present in an amount greater than or equal to about 0.1 g/m². A diclad circuit material further comprises a second copper layer on the opposite side of the circuit substrate, preferably together with a second thick silane layer.

In yet another aspect, a circuit comprises as copper foil adjacent to and in contact with a first side of a first thick silane layer, which is disposed on a first side of a circuit substrate. A circuit layer, i.e., a patterned conductive layer, is disposed on a second side of circuit substrate, preferably with a second thick silane layer to provide enhanced adhesion between the substrate and the patterned conductive layer.

In another aspect, a method of making a coated foil is provided. The method comprises coating a copper foil with a solution comprising about 1 wt % to about 20 wt % of at least one silane and a carrier, removing the carrier, and curing the silane.

When the silanated copper foil is used in the manufacture of circuit boards, the resulting circuits demonstrate a significantly lower amount of acid undercut when compared to circuits manufactured using copper foils without the thick silane layer. The above-discussed and other features and advantages will be appreciated and understood by those skilled in the art from the following detailed description and drawings.

### BRIEF DESCRIPTION OF DRAWINGS

Referring now to the exemplary drawings wherein like elements are numbered alike in the several figures:

FIG. 1 shows an exemplary silanated copper foil.

FIG. 2 shows an exemplary single clad circuit material comprising a thick silane layer.

FIG. 3 shows an exemplary diclad circuit material comprising a thick silane layer.

FIGS. 4A and 4B show an exemplary diclad circuit comprising (A) a thick silane layer, and (B) two thick silane layers.

FIG. 5 shows an exemplary silanated copper foil with an elastomer layer.

FIG. 6 shows an exemplary circuit material comprising a thick silane layer and an elastomer layer.

FIG. 7 shows an exemplary diclad circuit material comprising a thick silane layer and an elastomer layer.

FIGS. 8A and 8B show an exemplary circuit comprising (A) a thick silane layer and an elastomer layer and (B) two thick silane layers and elastomer layers.

FIG. 9 is a graph showing the effects of various silane coating thicknesses on the peel strength of elastomer-coated copper foils.

FIG. 10 is an SEM (Scanning Electron Micrograph) of a copper foil with a conventional thin silane coating typically applied by copper foil manufacturers.

FIG. 11 is an SEM of a copper foil with a thick silane coating in accordance with the present invention.

### DETAILED DESCRIPTION

Where acid undercutting presents itself in processing circuits and circuit materials, use of a silanated copper foil having a silane layer in an amount greater than or equal to about 0.1 g/m² results in decreased acid undercutting and thus improved bond strength retention. As used herein, a circuit material is defined as a conductive layer fixedly attached to a dielectric substrate. The presence of the thick silane layer on the copper foil reduces the loss of bond strength between the dielectric substrate and the copper foil that can occur during the formation of a circuit from the circuit material. In the case of a copper foil with a thermal barrier, the presence of a thick silane layer also reduces the amount of acid undercut experienced during acidic treatment.

It is known to use silanes to modify surfaces for a number of purposes, usually using very small amounts, such as one or several monomolecular layers of the silane. The silanes are thought to react with metal oxides or hydroxides to form a strong chemical bond directly with the surface being modified. Alternatively, the silane may be used to change the surface energy of the modified surface for better wettability of the surface, or may provide a chemical bond between the surface and a resin brought in contact with the surface.

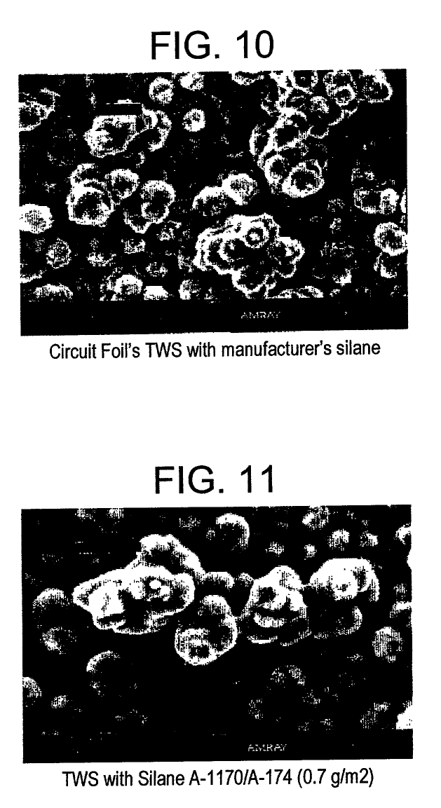

It is further known that copper manufacturers often treat copper foils with a thin layer of a silane. These thin layers are much less than 0.1 micrometer thick. As shown in FIG. 10, and illustrated in Example 47, the silane in these commercially treated samples is often present in an amount less than 0.01 g/m². Since surface of copper foils are not smooth, due to the fine nodular features as shown in FIG. 10, thin coating of silanes are expressed in weight uptake of g/m². However, the conventional thin layers of silane are not effective in reducing acid undercut. There accordingly still remains a need for methods for improving bond retention after acid treatment in those cases where acid undercut is observed.

Suitable copper foils include those presently used in the formation of circuits, for example, electrodeposited copper foils. Useful copper foils typically have thicknesses of about 9 to about 180 micrometers. Copper foils can also be treated to increase surface area, treated with a stabilizer to prevent oxidation of the foil (i.e., stainproofing), or treated to form a thermal barrier. Both low and high roughness copper foils treated with zinc or zinc alloy thermal barriers are particularly useful, and may further optionally comprise a stain-proofing layer. Such copper foils are available from, for examples, Yates Foil, USA under the trade names “TWX” and “TW”, Oak-Mitsui under the tradename “TOB”, Circuit Foil Luxembourg under the tradename “TWS”, and Gould Electronics under the tradename “JTCS”. Other suitable copper foils are available from Yates Foil under the trade name “TAX”; from Circuit Foil Luxembourg under the trade name “NT TOR”; from Co-Tech Copper Foil Company under the trade name “TAX”; and from Chang Chun Petrochemical Company under the trade name “PINK”.

Useful silanes include, but are not limited to, organosilanes having the structures (I) or (II):

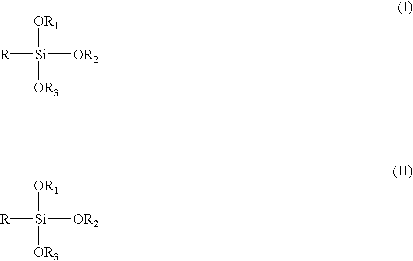

wherein R is an alkyl group with one to about eighteen carbons, or a vinyl, methacrylato, mercapto, epoxy, ureido, isocyanato, phenyl, amino or polyamino group, alone or substituted on an alkyl group with from 1 to 6 carbons; and R₁, R₂ and R₃ are the same or different and selected from alkyl and acetyl groups with one to about eighteen carbons. Other functional groups that do not interfere with the reaction or product characteristics may also be present, for example ether groups. Preferably, R is a vinyl group alone, or a vinyl, methacrylato, epoxy, or amino group, alone or substituted on an alkyl group with from 1 to 6 carbons, and R₁, R₂, and R₃ are the same and are methyl, ethyl, or acetoxy. Preferred organosilanes include but are not limited to gamma-methacryloxypropyltrimethoxy silane, available under the trade names Silquest A-174 from OSi Specialties, Inc.; gamma-glycidoxypropyltrimethoxysilane, available under the trade name Silquest A-187 from OSi Specialties, Inc., and vinyltriacetoxysilane available under the tradename VTAS and under the catalogue number SIV9098.8 from Gelest Inc.

Bis-silane compounds or other compounds with higher silane functionality may also be used, for example bis-silanes having the following structure (III):

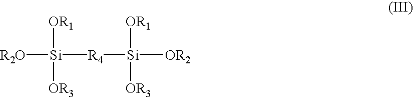

wherein each R₁, R₂, R₃ are the same or different and are selected from alkyl and acetyl groups with one to about eighteen carbons, and R₄ is an aromatic or alkyl-substituted group with two to about twenty-four carbons, a linear alkyl group with one to about eighteen carbons, or an alkyl amino group having from one to about eighteen carbons. A preferred bis-silane is bis(gamma-trimethoxysilylpropyl)amine, represented by Formula III above wherein R₁ is methyl and R₄ is —(CH₂)₃NH(CH₂)₃—. This silane is availably under the trade name Silquest A-1170 from OSi Specialties, Inc.

Another useful type of silane is a tris compound having the following structure (IV):

R₅[Si(OR₁)(OR₂)(OR₃)]₃ (IV)

wherein each R₁, R₂, R₃ are the same or different and are selected from alkyl and acetyl groups with one to about eighteen carbons, and R₅ an isocyanato group.

Other useful silanes include polymeric types, such as trimethoxy-, triacetoxy-, or triethoxysilyl modified poly-1,2-butadiene, or aminoalkyl silsequioxanes wherein the alkyl group has two to about 10 carbon, for example gamma-aminopropylsilsesquioxane, available under the trade name Silquest A-1106 from OSi Specialties, Inc.

The silanes may be used singly or in combination. A preferred combination is a bis-silane with an organosilane. The ratios of bis-silane to organosilane may vary, but typically is about 10:1 to about 1:10, and preferably about 5:1 to about 1:5. A preferred combination is Silquest A-1170 and Silquest A-174.

In practice, the silane or mixture of silanes is combined with a carrier for application, for example, a solvent. Useful solvents are those that are capable of dissolving the silane or mixture of silanes at the concentrations described below and may be aqueous or organic. Typical organic solvents include, for example, ethanol, methanol, acetone, and mixtures comprising one or more of the foregoing carriers. Silane solution concentrations are typically about 1 weight percent (wt %) to about 20 wt % of the total weight of the solution and preferably about 2 wt % to about 15 wt % of the total weight of the solution. The pH of the solution may be adjusted depending on the chosen silane or silanes. Additionally it may be useful to add water to silane solutions using organic solvents in order to facilitate hydrolysis, preferably in an amount up to about 80 wt % water, more preferably up to about 60 wt % water. The ranges of pH and the amount of water used, and the appropriate choices of silanes depend on the system in question, and are described by the manufacturer's literature such as OSi Specialties, Division of Crompton, brochure “Organofunctional Silanes: Application techniques”, and texts on the subject (“Silane Coupling Agents” 2^{nd} Edition, by Edwin Pleuddemann; Plenum Press, New York, 1991). The silanes themselves are esters of silicic acid, which must first be hydrolyzed with water in order to be active for chemical attachment to the copper. Alternatively, hydrolysis may proceed after application of the silane to the surface through reaction with adventitious water already on the copper foil surface. The silane can be coated onto the copper foil by various methods including rod coating, spray coating, reverse gravure roll, slotted die coating, and other coating methods known in the art.

The choice of coating method is not critical and generally depends on the scale of the preparation. A method useful in laboratory scale preparation is rod coating, wherein a thin line of solution is poured across one end of the copper foil sheet, and the solution is drawn down the copper foil in a thin uniform layer on the copper foil using a wire wound rod.

After the silane solution is applied, the carrier is removed, typically by evaporation. Evaporation and curing may proceed at room temperature, or the silanated copper foil may be heated. Preferably the silanated copper foil is heated at a temperature of about 30° C. to about 180° C. for about 10 seconds to about 180 minutes, depending on the temperature. The thickness of the layer depends on the concentration of the solution and the size of the wire on the wire wound rod. The silane layer is present on the copper foil in an amount of about 0.1 to about 2 g/m² (grams per square meter), preferably about 0.3 to about 1.0 g/m²

The silane layer on the copper foil may optionally be coated with an elastomer to form an elastomer layer. Useful elastomeric polymers and copolymers include ethylene-propylene rubber (EPR); ethylene-propylene-diene monomer elastomer (EPDM); styrene-butadiene rubber (SBR); styrene butadiene block copolymers; 1,4-polybutadiene; other polybutadiene block copolymers such as styrene-isoprene-styrene triblock (SIS), styrene-(ethylene-butylene)-styrene triblock (SEBS), styrene-(ethylene-propylene)-styrene triblock (SEPS), and styrene-(ethylene-butylene) diblock (SEB); polyisoprene; elastomeric acrylate homopolymers and copolymers; silicone elastomers; fluoropolymer elastomers; butyl rubber; urethane elastomers; norbornene and dicyclobutadiene-based elastomers; butadiene copolymers with acrylonitrile, acrylate esters, methacrylate esters, or carboxylated vinyl monomers; isoprene copolymers with acrylonitrile, acrylate esters, methacrylate esters, or carboxylated vinyl monomers; and mixtures comprising at least one of the foregoing elastomeric polymers and copolymers.

A preferred elastomeric polymer or copolymer is ethylene-propylene-diene monomer elastomer and more preferably an ethylene-propylene-diene monomer elastomer with an ethylene content of at least about 30%, more preferably at least about 50%, amd most preferably at least about 60% by weight. Preferred diene monomers are ethylidenenorbomene, dicyclopentadiene, 1,4-hexadiene, and butadiene. Preferred ethylene-propylene-diene monomer elastomers have a number average molecular weight of about 5,000 to about 2,000,000.

The elastomer may further comprise cross-linking agents, fillers, coupling agents, reactive monomers, antioxidants, and wetting agents. Suitable cross-linking agents include the types useful in cross-linking elastomeric polymers and copolymers, especially those useful in cross-linking ethylene-propylene-diene monomer elastomer. Examples include, but are not limited to, phenolic resins, melamine resins, azides, peroxides, sulfur, and sulfur derivatives. Free radical initiators are preferred as cross linking agents. Examples of free radical initiators include peroxides, hydroperoxides, and non-peroxide initiators such as 2,3-dimethyl-2,3-diphenyl butane. Preferred peroxide cross-linking agents include dicumyl peroxide, alpha, alpha-di(t-butylperoxy)-m/p-diisopropylbenzene, 2,5-dimethyl-2,5-di(t-butylperoxy)hexane-3, and 2,5-dimethyl-2,5-di(t-butylperoxy)hexyne-3 (DYBP). The cross-linking agent, when used, is typically present in an amount of about 1 to about 15 parts per hundred elastomer (phr).

Examples of optional fillers include titanium dioxide (rutile and anatase), barium titanate, strontium titanate, silica, including fused amorphous silica, corundum, wollastonite, aramide fibers (e.g., KEVLAR™ from DuPont), fiberglass, Ba₂Ti₉O₂₀, glass spheres, quartz, boron nitride, aluminum nitride, silicon carbide, beryllia, alumina or magnesia, used alone or in combination. The above named particles may be in the form of solid, porous, or hollow particles. Particularly preferred fillers are rutile titanium dioxide and amorphous silica. To improve adhesion between the fillers and polymer, the filler may be treated with one or more coupling agents, such as silanes, zirconates, or titanates. Fillers, when present, are typically present in an amount of about 0.5 volume % to about 60 volume % of the total volume of the composition.

Coupling agents may be used to promote the formation of or participate in covalent bonds connecting the filler surface with a polymer. Exemplary coupling agents include 3-mercaptopropylmethyldimethoxysilane and 3-mercaptopropyltrimethoxysilane. Coupling agents, when used, may be added in the amounts of about 0.1 wt % to about 1 wt % of the total weight of the elastomer.

Wetting agents may be useful additives to the elastomer or silane to improve wetting, promote adhesion or both improve wetting and promote adhesion. Examples of these materials include, but are not limited to, polyether polysiloxane blends such as Coat-O-Sil 1211 available from Witco and BYK 333 available from BYK Chemie, and fluorine-based wetting agents such as ZONYL FSO-100 from DuPont. Such wetting agents, when employed, maybe used in amounts of about 0.1 wt % to 2 wt % of the total weight of the elastomer.

Co-curing components are reactive monomers with unsaturation or polymers such as 1,2-polybutadiene polymers, which may be included in the solution for a specific property or for specific processing conditions. Inclusion of one or more co-curing components has the benefit of increasing crosslink density upon cure. Suitable reactive monomers must be capable of co-reacting with the elastomeric polymer or copolymer and/or the thermosetting composition. Examples of suitable reactive monomers include styrene, divinyl benzene, vinyl toluene, divinyl benzene, triallylcyanurate, diallylphthalate, and multifunctional acrylate monomers (such as Sartomer compounds available from Sartomer Co.), among others, all of which are commercially available. Useful amount of co-curing components, when present, are about 0.5 wt % to about 50 wt % of the total weight of the elastomer.

Useful antioxidants include radical scavengers and metal deactivators. A non-limiting example of a free radical scavenger is poly[6-(1,1,3,3-tetramethylbutyl)amino-s-triazine-2,4-dyil][(2,2,6,6,-tetramethyl-4-piperidyl)imino]hexamethylene[(2,2,6,6-tetramethyl-4-piperidyl)imino]] commercially available from Ciba Chemicals under the tradename Chimmasorb 944. A non-limiting example of a metal deactivator is 2,2-oxalyldiamido bis[ethyl 3-(3,5-di-t-butyl-4-hydroxyphenyl)propionate] commercially available from Uniroyal Chemical (Middlebury, Conn.) under the tradename Naugard XL-1. Antioxidants are typically used in an amount up to about 2 wt % of the total weight of the elastomer with about 0.1 wt % to about 0.6 wt % preferred.

The silanated copper foil may then be laminated using sufficient heat and pressure to a circuit substrate to form a circuit material. Useful substrates comprise dielectric polymeric compositions, which may include particulate fillers, fabric, elastomers, flame retardants, and other components known in the art. The polymeric component may be, although not restricted to, butadiene, isoprene based resins, epoxy, cyanate ester, polyphenylene ether, allylated polyphenylene ether, polyester, bismaleimide triazene (BT) resins, and the like. Preferably the polymeric composition is a thermosetting composition and thermosetting compositions containing polybutadiene, polyisoprene, and/or polybutadiene and polyisoprene copolymers are especially preferred. Particularly preferred thermosetting compositions are RO4350B and RO4003, both available from Rogers Corporation, Rogers, Conn., processed as described in U.S. Pat. No. 5,571,609 to St. Lawrence et al., which is herein incorporated by reference. These thermosetting compositions generally comprises: (1) a polybutadiene or polyisoprene resin or mixture thereof; (2) an optional unsaturated butadiene- or isoprene-containing polymer capable of participating in cross-linking with the polybutadiene or polyisoprene resin during cure; (3) an optional low molecular weight polymer such as ethylene propylene rubber or ethylene-propylene-diene monomer elastomer; and (4) optionally, monomers with vinyl unsaturation.

The polybutadiene or polyisoprene resins may be liquid or solid at room temperature. Liquid resins may have a molecular weight greater than or equal to about 5,000, but preferably have a molecular weight of less than or equal to about 5,000. The preferably liquid (at room temperature) resin portion maintains the viscosity of the composition at a manageable level during processing to facilitate handling, and it also cross-links during cure. Polybutadiene and polyisoprene resins having at least about 90% 1,2-addition by weight are preferred because they exhibit the greatest cross-link density upon cure owing to the large number of pendant vinyl groups available for cross-linking.

The thermosetting composition optionally comprises functionalized liquid polybutadiene or polyisoprene resins. Examples of appropriate functionalities for butadiene liquid resins include but are not limited to epoxy, maleate, hydroxy, carboxyl and methacrylate. Examples of useful liquid butadiene copolymers are butadiene-co-styrene and butadiene-co-acrylonitrile. The optional, unsaturated polybutadiene- or polyisoprene-containing copolymer can be liquid or solid. It is preferably a solid, thermoplastic elastomer comprising a linear or graft-type block copolymer having a polybutadiene or polyisoprene block, and a thermoplastic block that preferably is styrene or α-methyl styrene. The unsaturated butadiene- or isoprene-containing polymer may also contain a second block copolymer similar to the first except that the polybutadiene or polyisoprene block is hydrogenated, thereby forming a polyethylene block (in the case of polybutadiene) or an ethylene-propylene copolymer (in the case of polyisoprene). When used in conjunction with the first copolymer, materials with enhanced toughness can be produced. Where it is desired to use this second block copolymer, a preferred material is Kraton GX1855 (commercially available from Shell Chemical Corp.), which is believed to be a mixture of styrene-high 1,2 butadiene-styrene block copolymer and styrene-(ethylene-propylene)-styrene block copolymer.

The volume to volume ratio of the polybutadiene or polyisoprene resin to butadiene- or isoprene-containing polymer preferably is between 1:9 and 9:1, inclusive. The selection of the butadiene- or isoprene-containing polymer depends on chemical and hydrolysis resistance as well as the toughness conferred upon the laminated material.

The optional low molecular weight polymer resin is generally employed to enhance toughness and other desired characteristics of composition. Examples of suitable low molecular weight polymer resins include, but are not limited to, telechelic polymers such as polystyrene, multifunctional acrylate monomers, EPR, or EPDM containing varying amounts of pendant norbomene groups and/or unsaturated functional groups. The optional low molecular weight polymer resin can be present in amounts of about 0 to about 30 wt % of the total resin composition.

Monomers with vinyl unsaturation may also be included in the resin system for specific property or processing conditions, especially with high filler loading, and has the added benefit of increasing cross-link density upon cure. Examples of suitable monomers include styrene, vinyl toluene, divinyl benzene, triallylcyanurate, diallylphthalate, and multifunctional acrylate monomers (such as Sartomer compounds available from Arco Specialty Chemicals Co.), among others, all of which are commercially available. The useful amount of monomers with vinyl unsaturation is about 0 to about 80 wt % of the total resin composition and preferably about 3 wt % to about 50 wt % of the total resin composition.

A curing agent is preferably added to the resin system to accelerate the curing reaction. Preferred curing agents are organic peroxides such as, dicumyl peroxide, t-butyl perbenzoate, 2,5-dimethyl-2,5-di(t-butyl peroxy)hexane, (α,α-di-bis(t-butyl peroxy)diisopropylbenzene, and 2,5-dimethyl-2,5-di(t-butyl peroxy) hexyne-3, all of which are commercially available. They may be used alone or in combination. Typical amounts of curing agent are from about 1.5 phr to about 10 phr of the total resin composition.

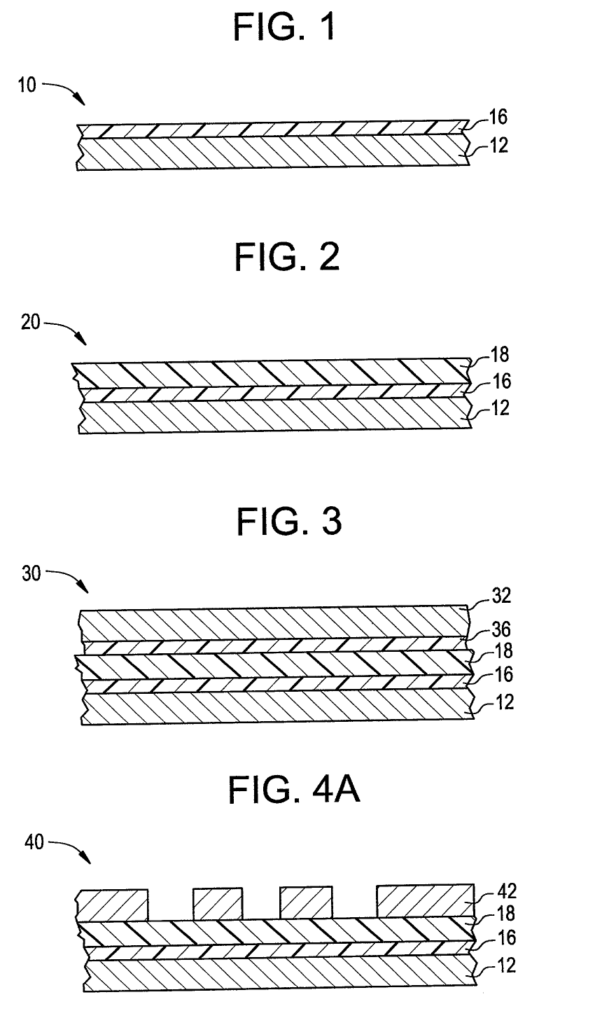

In accordance with various preferred embodiments of the present invention, FIG. 1 shows an exemplary coated metal foil 10 comprising thick silane layer 16 disposed on and in intimate contact with copper foil 12. It is to be understood that in all of the embodiments described herein, the various layers may fully or partially cover each other, and that additional copper foil layers, patterned circuit layers, and dielectric layers may also be present.

FIG. 2 shows an exemplary single clad circuit material 20 comprising thick silane layer 16 between a dielectric layer 18 and copper foil 12.

FIG. 3 shows an exemplary diclad circuit material 30 comprising a first thick silane layer 16 between a first side of dielectric layer 18 and copper foil 12. Second thick silane layer 36 is between a second copper foil 32 and a second side of dielectric layer 18. The first and second silane layers 16, 36 may be the same or different and first and second copper foils 12, 32 may be the same or different. Only one thick silane layer may be used (not shown), or a bond ply layer may replace one thick silane layer.

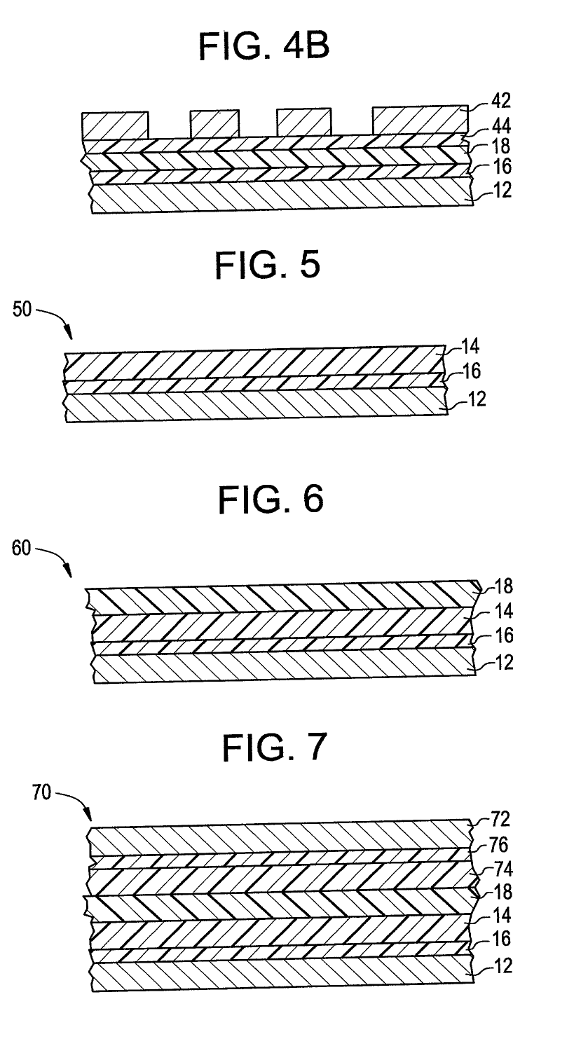

FIG. 4A shows an exemplary circuit 40 comprising copper foil 12 adjacent to and in contact with a first side of thick silane layer 16, which is disposed on a first side of a circuit substrate 18. A patterned (e.g., etched) conductive metal circuit layer 42 is disposed on a second side of circuit substrate 18. Alternatively, as shown in FIG. 4B, a thick silane layer 44 may be present between foil 42 and dielectric layer 18. The first and second silane layers 16, 44 may be the same or different.

In an alternative embodiment, FIG. 5 shows an exemplary coated metal foil 50 comprising silane layer 16 disposed between copper foil 12 and elastomer layer 14.

FIG. 6 shows an alternative exemplary circuit material 60 comprising silane layer 16 disposed between copper foil 12 and elastomer layer 14, and further comprising dielectric layer 18 disposed on elastomer layer 14 on a side opposite silane layer 16.

FIG. 7 shows an alternative exemplary diclad circuit material 70 comprising the diclad circuit material of FIG. 3, wherein a first elastomer layer 14 is disposed between first silane layer 16 and dielectric layer 18. A second elastomer layer 74 is disposed between second silane layer 76 and second copper foil 72. The first and second silane layers 16, 76 may be the same or different, the first and second elastomer layers 14, 74, and first and second copper foils 12, 72 may be the same or different. Aslternatively, only one elastomer layer may be present (not shown).

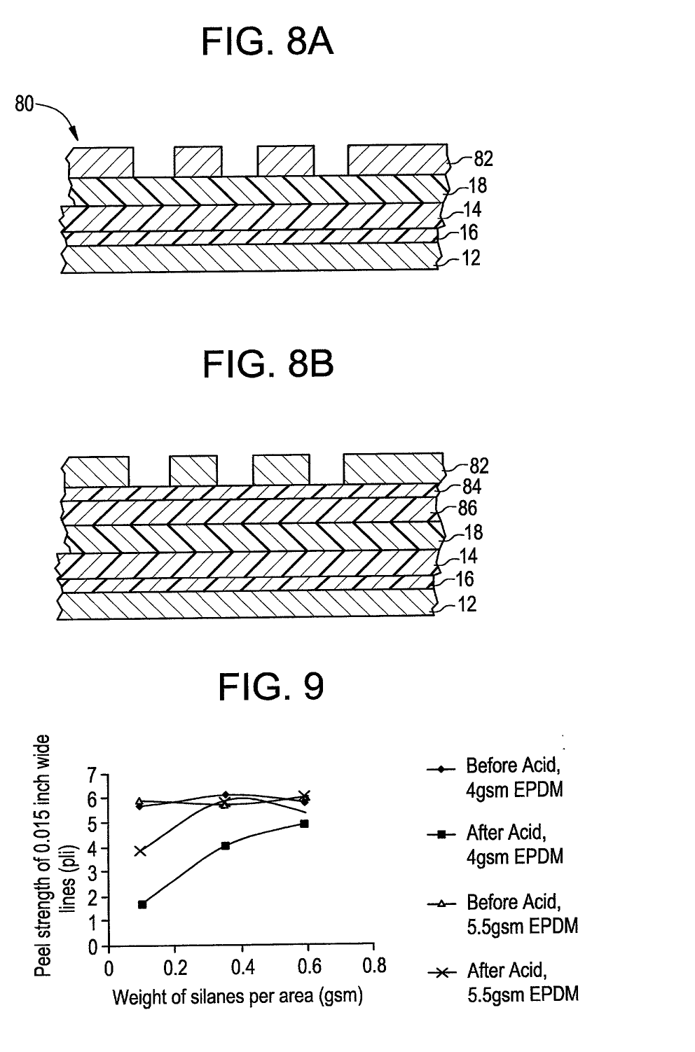

FIG. 8A shows an exemplary circuit 80 comprising copper foil 12 adjacent to and in contact with a first side of thick silane layer 16, which is disposed on elastomer layer 14, which is disposed on a first side of a circuit substrate 18. An etched metal circuit layer 82 is disposed on a second side of circuit substrate 18. Alternatively, as shown in FIG. 8B, a second thick silane layer 84 may be placed between substrate 18 and circuit 82, together with a second elastomer layer 86 between silane layer 84 and circuit substrate 18. The first and second silane layers 16, 84 may be the same or different and the first and second elastomer layers 14, 86 may be the same or different. Additional copper foil layers, patterned circuit layers, and dielectric layers may also be present in the above-described embodiments.

The invention is further illustrated by the following non-limiting Examples.

### EXAMPLES

In the following examples all concentrations are in weight % based on total weight of the applied solution. All copper foils are ½ oz/ft². In all examples, peel strength testing was performed using the method of IPC-TM-650 2.4.8 using 0.015-inch (0.38 mm) wide parallel copper lines (traces).

### Comparative Example 1

TWX copper foil, containing a zinc thermal barrier and without silane added by the manufacturer and available from Yates Foil, USA was laid up with six layers of RO4350B prepreg available from Rogers Corporation, Rogers Conn., and laminated using Lamination Cycle 1 as follows:

Initial conditions are 93° C. (200° F.) and 6.9 Mega Pascals (MPa) (1000 pounds per square inch (psi));

Temperature is ramped from 93° C. to 174° C. (345° F.) at 1.1° C. (2° F.) per minute;

Dwell at 174° C. for 15 minutes;

Ramp to 246° C. (475° F.) at 4.7° C. (7.6° F.) per minute;

Ramp to 246° C. (475° F.) at 4.7° C. (7.6° F.) per minute;

Drop pressure to 400 psi and ramp down temperature to 204° C. (400° F.) at 2.8° C. (5° F.) per minute;

Dwell at 204° C. for 60 minutes; and

Ramp down to 93° C. at 2.8° C. per minute.

On the resulting copper clad laminate, 0.015 inch wide parallel copper lines (traces) were produced using photo-lithographic techniques and etching with ammoniacal cupric chloride. The peel strength of three “As-Is” traces, which were not exposed to the acid conditioning described below, was measured and average peel strength was 3.9 pounds per linear inch (pli).

The circuit materials containing the rest of the traces were then subjected to acid undercut conditioning. Acid undercut conditioning comprises exposing the laminate to a 10% sulfuric acid solution at 75° C. for 5 minutes, rinsing in distilled water, and drying at 50° C. for 10 minutes, which simulates the steps of ENIG processing that can result in acid undercutting. The conditioned boards were tested for peel strength. Average peel strength was 2.5 pli, or a loss of 36% of the initial peel strength.

The above described method of lamination, conditioning and testing were used in the following examples.

### Example 2

Copper foil from the same copper foil lot used in Example 1 was used in Example 2. The foil was coated with a solution comprising a mixture of 50 wt % Silquest A-174 silane and 50 wt % Silquest A-1170 silane from OSi Specialties, Inc., based on the total silane weight, at a total solution concentration of 9 wt % silane in water/ethanol (60/40, by wt) solvent. The silane solution was applied on a pilot plant coating line using a #8 wire wound rod with a web speed of 15 feet/min. The resulting silanated copper foil was dried by passing it through a three-zone air circulating oven with an exit temperature set in the range of 98 to 110° C.

### Example 3

Example 3 was prepared as described in Example 2 except the silane coating was A-174 silane from OSi Specialties, Inc. at a concentration of 5 wt % silane in ethanol.

### Comparative Example 4

Comparative Example 4 was prepared as described in Comparative Example 1 except TW copper, a low roughness copper foil with a manufacturer applied silane treatment, available from Yates, USA, was used. Reference to Table 1 illustrates that conventional amounts and types of silane used by copper manufacturers is ineffective in protecting from acid undercut.

### Example 5

Example 5 was prepared as described in Example 2, except the copper foil employed was TW copper foil, the low roughness copper foil used in Comparative Example 4.

### Comparative Example 6

Comparative Example 6 was prepared as described in Comparative Example 1, except a copper foil having a manufacturer-applied thin silane coating available under the tradename JTCS from Gould Electronics Foil Division, Eastlake, Ohio, was used. The initial bond using this copper is substantially lower than that of the previous examples.

### Example 7

Example 7 was prepared as described in Example 2 except the copper foil as described in Comparative Example 6 was used.

TABLE 1

| | | | | Bond | Bond strength | |
|---|---|---|---|---|---|---|
| | | | Total Silane | strength, | after acid | % Bond strength |
| | | | Concentration, | “As-Is”, | treatment, | retention after |
| Ex. No. | A-174 | A-1170 | wt % | pli | pli | acid treatment |
| 1* | None | None | None | 3.9 | 2.5 | 64% |
| 2 | A-174 | A-1170 | 9% | 4.0 | 3.6 | 90% |
| 3 | A-174 | — | 5% | 4.0 | 3.1 | 78% |
| 4* | None | None | None | 4.1 | 2.8 | 68% |
| 5 | A-174 | A-1170 | 9% | 3.7 | 3.4 | 92% |
| 6* | None | None | None | 2.9 | 0.3 | 10% |
| 7 | A-174 | A-1170 | 9% | 2.7 | 2.0 | 74% |

*Comparative examples.
“None” indicates no silanes added beyond manufacturer

As may be seen from the above data, silane treatment increases bond strength retention from 10-68% in the untreated controls to 78-92% in the treated examples.

Examples 8 through 13 were prepared as described in Comparative Example 1 with the addition of a silane layer and an elastomeric coating comprising Royalene 301T, an ethylene-propylene-diene monomer elastomer available from Uniroyal Inc., Middlebury, Conn. The elastomeric coating was added on top of the silane layer.

### Example 8

The copper foil was coated using a 1% solution of A-174 silane, to provide a silane uptake of about 0.1 g/m². A 10% elastomer solution in xylene containing 5 phr DYBP peroxide based on the EPDM solids content was applied over the dried silane coating. A thin line of the elastomeric solution was poured across one end of the copper sheet, and drawn down with a #24 wire wound rod, to give an elastomer uptake level of about 4 g/m².

### Examples 9-10

Examples 9 and 10 were prepared as described in Example 8 except a 5 wt % or 10 wt % silane solution was used, to provide a silane uptake of about 0.36 g/m² and about 0.61 g/m², respectively.

### Examples 11-13

Examples 11, 12, and 13 were prepared as described in Examples 8, 9 and 10 respectively, except a #40 wire wound rod was used, producing an elastomeric uptake of about 5.5 g/m².

The results of Examples 8-13 are summarized in Table 2 and FIG. 9. As seen in Examples 8-13, it is seen that little protection of the copper from acid is afforded by a 1 wt % silane solution, and but the protection improves substantially at 5 wt %, and is greatest at 9 wt % silane.

TABLE 2

| Example | 8 | 9 | 10 | 11 | 12 | 13 |
|---|---|---|---|---|---|---|
| Silane Type | A-174 | A-174 | A-174 | A-174 | A-174 | A-174 |
| Concentration | 1.0% | 5.0% | 9.0% | 1.0% | 5.0% | 9.0% |
| of Silane | | | | | | |
| Approx. weight | 0.10 | 0.36 | 0.61 | 0.10 | 0.36 | 0.61 |
| uptake of | | | | | | |
| silane, g/m² | | | | | | |
| Rubber Type | R-301T | R-301T | R-301T | R-301T | R-301T | R-301T |
| Wire Wound | #24 | #24 | #24 | #40 | #40 | #40 |
| Rod # | | | | | | |
| Rubber Weight | 4.2 | 3.9 | 3.8 | 5.6 | 5.7 | 5.3 |
| Uptake, g/m² | | | | | | |
| As-is Bond | 5.69 | 5.88 | 5.60 | 5.84 | 5.6 | 5.8 |
| strength, pli | | | | | | |
| Bond strength | 1.65 | 3.85 | 4.70 | 3.82 | 5.7 | 5.1 |
| after acid | | | | | | |
| treatment, pli | | | | | | |
| % Bond | 29% | 65% | 84% | 65% | 102% | 88% |
| strength | | | | | | |
| retained after | | | | | | |
| acid | | | | | | |
| treatment | | | | | | |

### Examples 14-16

Examples 14, 15, and 16 show the use of copper foils coated with both rubber and other silanes. The Examples were prepared as described in Example 8 using TWX (treated with no silane by manufacturer) copper foil available from Yates Foil with different silanes. Example 14 employed a solution comprising a mixture of 50 wt % Silquest A-1170 silane and 50 wt % of a vinyl silane under the catalogue number SIV9098.0 available from Gelest, Inc., based on the total silane weight, at a total solution concentration of 5 wt % silane in water based on the total weight of the solution. Example 15 used a solution comprising a mixture of 50 wt % Silquest A-1170 silane and 50 wt % Silquest A-187 silane (an epoxy silane), based on the total silane weight, at a total solution concentration of 5 wt % silane in water based on the total weight of the solution. Example 16 used a solution containing A-1106 silane (an amino silane) at a total solution concentration of 5 wt % silane in ethanol based on the total weight of the solution. As shown in Table 3, the loss of bond due to the acid undercut conditioning was in a range of 0% to 14%.

TABLE 3

| Example | 14 | 15 | 16 |
|---|---|---|---|
| Rubber Weight Uptake, g/m² | 5.81 | 4.91 | 5.59 |
| Bond strength, pli, As-is | 5.59 | 5.62 | 5.61 |
| Bond strength after acid | 5.78 | 5.07 | 4.81 |
| treatment, pli | | | |
| % Bond strength retention after | 103 | 90 | 86 |
| acid treatment | | | |

### Examples 17-21

Examples 17-21 in Table 4 show acid undercut data on the copper foils coated with silanes. The silane treatment was done as in Example 2 and EPDM rubber coating as in Examples 11-13. Lamination, preparation of copper lines and acid undercut conditioning were done as in Example 1. The copper lines were peeled back from the dielectric substrate and the line width of the “red ring” was measured under optical microscope. As shown in Table 4, copper foils treated with silanes reduce or eliminate acid undercut in the test condition.

TABLE 4

| Example | Foil | Silane, wt % | EPDM, g/m² | Undercut, mil |
|---|---|---|---|---|
| 17 | TWX | A-174, 5% | 0 | 3.4 |
| 18 | TWX | A-174/A-1170(1/1), | 0 | 3.2 |
| | | 9% | | |
| 19 | TWX** | A-174/A-1170(1/1), | 0 | 0 |
| | | 9% | | |
| 20 | TWX | A-174/A-1170(1/1), | 5.5 | 0 |
| | | 9% | | |
| 21* | TWX** | None | 0 | 6.7 |

*comparative example
**with foil manufacturer's silane

### Examples 22-30

The copper foil was 0.5 oz TAX from Yates Foil, USA, which has no zinc thermal barrier layer. The foil was coated with a solution comprising Silquest A-174 silane, a mixture of 50 wt % Silquest A-174 silane and 50 wt % Silquest A-1170 silane, a mixture of 50 wt % Silquest A-1170 silane and 50 wt % VTAS vinyl silane (Gelest, Inc, Tullytown, Pa.), a mixture of 50 wt % Silquest A-1170 silane and 50 wt % Silquest A-187, or Silquest A-1106 silane, based on the total silane weight. The total solution concentration was 9 wt % silane. For Silquest A-174 silane and the mixture of 50 wt % Silquest A-174 silane and 50 wt % Silquest A-1170 silane the solvent was water/ethanol (60/40, by weight). For the remaining silanes, the solvent was water. The silane solution was applied on a pilot plant coating line using a #8 wire wound rod with a web speed of 15 feet/min. The resulting silanated copper foil was dried by passing it through a three zone air circulating oven with an exit temperature set in the range of 98 to 110° C.

The elastomeric coating comprising Royalene 301T, an EPDM available from Uniroyal Inc., Middlebury, Conn., was added on top of the silane layer.

Results are shown in Table 5.

TABLE 5

| | | | | | | % Bond |
|---|---|---|---|---|---|---|
| | | Weight | Weight of | | Bond strength | strength |
| | | of silane | elastomer | Bond strength, | after acid | retention |
| | | per area, | per area, | “As-Is”, | treatment, | after acid |
| Example | Silane | (g/m²) | (g/m²) | pli | pli | treatment |
| 22* | Thin silane** | | 6.0 | 5.5 | 5 | 91 |
| 23* | None | | 4.0 | 5.2 | 4.6 | 88 |
| 24 | A-174 | 0.06 | 3.7 | 5.3 | 5.2 | 98 |
| 25 | A-174 | 0.53 | 5.6 | 5.8 | 5.2 | 90 |
| 26 | A-1170/ | 0.157 | 3.8 | 5.4 | 5.3 | 98 |
| | A-174 | | | | | |
| 27 | A-1170/ | 0.564 | 5.6 | 5.4 | 5.3 | 98 |
| | A-174 | | | | | |
| 28 | A-1170/ | NA*** | 6.09**** | 6.2 | 7.6 | >100 |
| | VTAS | | | | | |
| 29 | A-1170/ | NA | 5.7**** | 5.9 | 6.4 | >100 |
| | A-187 | | | | | |
| 30 | A-1106 | NA | 4.87**** | 5.7 | 6.0 | >100 |

*Control Example
**Manufacturer's silane treatment
***NA—not available.
****Weight of silane plus elastomer per area.

As shown in Table 5, all samples, including comparative Examples 22 and 23, have some improvement in the “as-is” bond strength due to the presence of the elastomer. Applying silane as shown in Examples 24-30 results in some improvement in bond strength after acid treatment. The improvement in bond strength retention is up to about 12%.

### Examples 31-42

The effects of silane treatment on bond strength retention using different copper foils was determined. The foils used have no thermal barriers and are referred to as Copper 1 (Chang Chun PINK), Copper 2 (CoTech-TAX) and Copper 3 (CoTech-TAX, different lot number) Foils were treated with a 2:1 mixture of A174/A1170 in a water/ethanol mixture. The foils were then coated with a 70:30 (wt/wt) combination of Royalene 551/Royalene 301T EPDM in the laboratory Royalene 551 is an ethylene-propylene-diene monomer elastomer available from Uniroyal. The foils were laid up with five layers of RO4350B prepreg available from Rogers Corporation, Rogers Conn. Acid treatment was 10% H₂SO₄ at 75° C. for 5 minutes. Results are shown in Table 6.

TABLE 6

| | | | | | | % Bond |
|---|---|---|---|---|---|---|
| | | | | | Bond | strength |
| | | | | Bond | strength | retention |
| | | | Cu | strength, | after acid | after |
| | | | Trace, | “As-Is”, | treatment, | acid |
| Sample | Foil | Silane | mil | pli | pli | treatment |
| 31 | Cu 1 | Yes | 30 | 5.46 | 5.58 | 102 |
| 32 | Cu 1 | Yes | 15 | 5.4 | 5.35 | 99 |
| 33 | Cu 1 | No | 30 | 6.03 | 4.54 | 75 |
| 34 | Cu 1 | No | 15 | 5.88 | 4.57 | 77 |
| 35 | Cu 2 | Yes | 30 | 5.78 | 5.82 | 100 |
| 36 | Cu 2 | Yes | 15 | 5.32 | 4.9 | 92 |
| 37 | Cu 2 | No | 30 | 5.74 | 5.77 | 100 |
| 38 | Cu 2 | No | 15 | 5.91 | 5.24 | 89 |
| 39 | Cu 3 | Yes | 30 | 5.55 | 5.58 | 100 |
| 40 | Cu 3 | Yes | 15 | 5.04 | 4.74 | 94 |
| 41 | Cu 3 | No | 30 | 5.57 | 4.66 | 84 |
| 42 | Cu 3 | No | 15 | 5.25 | 4.01 | 76 |

For all samples in Table 6, no undercut is observed under the microscope. Untreated samples have bond retentions of 75-100%. The bond retention is 99-102% for the silane treated Copper 1 samples, 92-100% for the silane treated Copper 2 samples, and 94-100% for the silane treated Copper 3 samples. Thus, regardless of the manufacturer of the foils, treatment of all copper foils with silane results in improved bond strength retention.

### Examples 43-46

Table 7 shows examples of laminates prepared from ½ oz TWS foil (Circuit Foils, Luxemburg) with silane coating and a 4-mil epoxy-based prepreg available from Nelco under the trade name FR-4. The silane coating was a 1:1 mixture of Silquest A-174 and Silquest A-1170. The bond strength retention after acid undercut conditioning was improved by 15-20% for the laminates prepared with silane coating.

TABLE 7

| | | | | % Bond | |
|---|---|---|---|---|---|
| | Weight of | | | strength | |
| | silane per | | Bond | retention | |
| | area, | FR-4 | strength, | after acid | Undercut, |
| Examples | (g/m²) | prepreg | “As-Is”, pli | treatment | mil |
| 43* | none | 2 ply | 8.4 | 76 | 2.0 |
| 44* | none | 5 ply | 9.1 | 77 | 2.3 |
| 45 | 0.7 | 2 ply | 7 | 91 | 0.7 |
| 46 | 0.7 | 5 ply | 6.9 | 97 | 0.8 |

*Comparative examples

Silanated copper foils with a silane greater than or equal to about 0.1 g/m² have improved bond strengths after acid undercut relative to unsilanated foils or foils with a thin silane coating. The bond strength retention after acid treatment is 75-92% and even up to 100% in some cases with the inventive thick silane treatment. For untreated copper foils, the improvements observed are 9-12% while for foils with a barrier layer, the improvement in bond strength retention can be 25% or even higher. In addition, in the foils with a barrier layer, acid undercut can be reduced by greater than 50%, or in some cases even eliminated. Thus, copper foils with a thick silane layer demonstrate significantly improved properties over unsilanated foils or those with only a thin silane layer.

### Examples 47-49

Table 8 shows an estimated comparison between the amount of silane that is commonly provided on commercially available copper foil by the manufacturer with the amount of deposited silane in accordance with the present invention. The estimates are obtained by comparing the relative amount of silicon present on the surface of the foils by electron diffraction X-ray (EDX). The EDX measurements were performed on Amray SEM equipped with Kevex Sigma system. An accelerated voltage of 20 kV was used. The percent silicon was calculated based on the ratio of silicon/copper observed. Using the EDX data, amount of silane (in g/m²) on the control foil treated by manufacturer was estimated. As shown in Table 8, the amount of silane estimated to result from the manufacturer's treatment is very low, about 0.03 g/m², compared to the amount on the foil in accordance with the invention.

TABLE 8

| | | Si, % from | |
|---|---|---|---|
| Examples | Silane | EDX | Silane, g/m² |
| 47* | Manuf. silane | 0.11 | 0.033-0.035** |
| 48 | A-174/A-1170 | 2.3 | 0.70 |
| 49 | A-174/A-1170 | 2.6 | 0.85 |

*Control copper foil TWS from Circuit Foil Luxembourg
**Calculated

Additionally, when copper foil having a manufacturer applied thick silane layer is view by SEM, as shown in FIG. 10, fine nodular features of copper foil can be seen. In contrast, when a copper foil having a silane layer with silane present in an amount greater than 0.1 g/m² is viewed by the same technique, as shown in FIG. 11, nodular features of the foils are obscured and are rounded due to the presence of thicker silane layer.

While preferred embodiments have been shown and described, various modifications and substitutions may be made thereto without departing from the spirit and scope of the invention. Accordingly, it is to be understood that the present invention has been described by way of illustration and not limitation.

What is claimed is:

1. A coated foil comprising a thick silane layer disposed on the copper foil, wherein the silane layer is present in an amount greater than or equal to about 0.1 gram per square meter.

2. The coated foil of claim 1, wherein the silane has the formula (I) or (II): 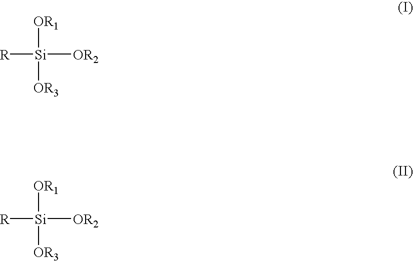
wherein R is an alkyl group with one to about eighteen carbons, or a vinyl, methacrylato, mercapto, epoxy, ureido, isocyanato, phenyl, amino or polyamino group, alone or substituted on an alkyl group with from 1 to 6 carbons, and R₁, R₂ and R₃ are the same or different and are selected from alkyl and acetyl groups with one to about eighteen carbons;
the formula (III): 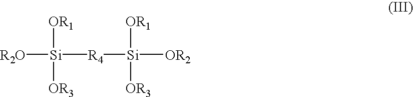
wherein each R₁, R₂, R₃ are the same or different and are selected from alkyl and acetyl groups with one to about eighteen carbons, and R₄ is an aromatic or alkyl-substituted group with two to about twenty-four carbons, a linear alkyl group with one to about eighteen carbons, or an alkyl amino group having from one to about eighteen carbons;
the formula (IV):
R₅[Si(OR₁)(OR₂)(OR₃)]₃ (IV)
wherein each R₁, R₂, R₃ are the same or different and are selected from alkyl and acetyl groups with one to about eighteen carbons R₅ an isocyanato group;
triacetoxy-, trimethoxy, or triethoxysilyl modified poly-1,2-butadiene;
aminoalkylsilsesquioxane wherein the alkyl group as two to about 10 carbon atoms; or a mixture comprising at least one of the foregoing silanes.

3. The coated foil of claim 1, wherein the silane has the formula (I) or (II): 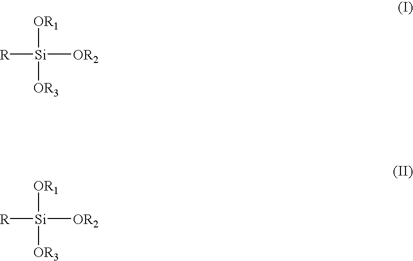
wherein R₁, R₂ and R₃ are the same or different and are methyl, ethyl, or acetoxy, and R is a vinyl group alone, or a vinyl, methacrylato, epoxy, or amino group, alone or substituted on an alkyl group with from 1 to 6;
the formula (III): 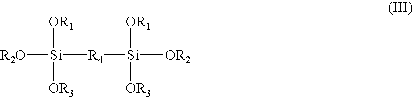
wherein R₁, R₂ and R₃ are the same or different and are methyl, ethyl, or acetoxy, and R₄ is a dialkyl alkyl amino group having from one to about eighteen carbons;
an aminoalkylsilsesquioxane wherein the alkyl group has two to about six carbons; or a mixture comprising at least one of the foregoing silanes.

4. The coated foil of claim 1, wherein the silane comprises gamma-methacryloxypropyltrimethoxysilane, gamma-glycidoxypropyltrimethoxysilane, vinyltriacetoxysilane, gamma-aminopropylsilsesquioxane, bis(gamma-trimethoxysilylpropyl)amine, or a mixture comprising at least one of the foregoing silanes

5. The coated foil of claim 2, wherein the silane comprises a silane of Formula (III) and a silane of Formula (I) in a ratio of about 10:1 to about 1:10.

6. The coated foil of claim 1, wherein the silane layer is present in an amount of about 0.1 to about 2 grams per square meter.

7. The coated foil of claim 3, wherein the silane layer is present in an amount of about 0.3 to about 1 gram per square meter.

8. The coated foil of claim 1, wherein the silane layer further comprises a filler additive.

9. The coated foil of claim 1, wherein the copper layer further comprises a thermal barrier.

10. The coated foil of claim 1, further comprising an elastomer layer disposed on a side of the silane layer opposite the copper foil.

11. The coated foil of claim 10, wherein the elastomer layer comprises an ethylene-propylene-diene monomer elastomer.

12. A circuit material, comprising
a silane layer disposed between a copper foil and a first side of a circuit substrate, wherein the silane layer is present in an amount greater than or equal to about 0.1 grams per square meter.

13. The circuit material of claim 12, further comprising an elastomer layer between the silane layer and the first side of the circuit substrate.

14. The circuit material of claim 12, further comprising a second copper foil disposed on a second side of the circuit substrate.

15. The circuit material of claim 12, further comprising a second silane layer between the second copper foil and the second side of the circuit substrate, wherein the silane layer is present in an amount greater than or equal to about 0.1 grams per square meter.

16. The circuit material of claim 11, further comprising a second elastomer layer between the second silane layer and the second side of the circuit substrate.

17. A circuit comprising:
a copper foil;
a silane layer, wherein the silane layer is present in an amount greater than or equal to about 0.1 grams per square meter;
a circuit substrate having a first and second side; and
a patterned circuit layer, wherein the copper foil is disposed on the first side of the circuit substrate material, the patterned circuit layer is disposed on the second side of the circuit substrate material, and the first silane layer is disposed between at least one of the copper foil and the first side of the circuit substrate material or between the patterned circuit layer and the second side of the circuit substrate material.

18. The circuit of claim 17, further comprising an adhesion promoting elastomer layer between the silane layer and the first side of the circuit substrate or between the patterned circuit and the second side of the circuit substrate material.

19. The circuit of claim 17, further comprising a second silane layer, wherein the first silane layer is disposed between the copper foil and the first side of the circuit substrate material, and the second silane lahyer is disposed between the patterned circuit and the second side of the circuit substrate material, wherein each silane layer is present in an amount greater than or equal to about 0.1 g/m².

20. The circuit of claim 19, further comprising an adhesion promoting elastomer layer between at least one of the first silane layer and the first side of the circuit substrate material or between the second silane layer and the second side of the circuit substrate material.

21. The circuit of claim 20, further comprising a first adhesion promoting elastomer layer between the first silane layer and the first side of the circuit substrate material and a second elastomer layer between the second silane and the second side of the circuit substrate material,

22. A method of making a coated foil comprising:
coating a copper foil with a silane; and
curing the silane to provide a silane coating in an amount greater than or equal to about 0.1 g/m².

23. The method of claim 22, wherein the silane is applied with a carrier, and the carrier is removed before or during curing.

24. The method of claim 23, wherein the carrier comprises water, ethanol, methanol, acetone, or a mixture comprising one or more of the foregoing carriers.
